(19) United States
(12) Patent Application Publication
(10) Pub. No.: US 2020/0159729 A1
(43) Pub. Date: May 21, 2020

(54) Search Retrieval System and Method

(71) Applicant: The University of Texas at Tyler, Tyler, TX (US)

(72) Inventors: Narayanan Subramanian, Tyler, TX (US); Andrew Fobel, Tyler, TX (US)

(21) Appl. No.: 16/688,907

(22) Filed: Nov. 19, 2019

Related U.S. Application Data
(60) Provisional application No. 62/769,185, filed on Nov. 19, 2018.

(51) Int. Cl. G06F 16/2453

(52) U.S. Cl. CPC G06F 16/24532

(57) ABSTRACT

A system and method for searching and retrieving variable-length identifiers using a GPU. The system and method may conduct a fast search and retrieval of RDF triple stores or any key-value stores on a GPU and may provide fast and efficient parallel processing. The system and method for search and retrieval may be performed exclusively on the GPU which may provide extreme parallelism and higher performance than traditional systems and methods.

### CROSS-REFERENCE TO RELATED APPLICATION

This application claims the benefit under 35 U.S.C. § 119(e) of U.S. Provisional Patent Application Ser. No. 62/769,185 filed on Nov. 19, 2018, which is incorporated by reference in its entirety.

### TECHNICAL FIELD

The disclosure relates generally to searching and retrieving variable-length identifiers. In particular, the disclosure relates to searching and retrieving variable-length identifiers using a Graphics Processing Unit (GPU).

### BACKGROUND

Typically, the architecture of a modern computer can provide a GPU, as depicted in FIG. 1, that can be connected to a (Peripheral Component Interconnect Express (PCIe)) bus. The GPU can have several thousand cores that can share an onboard level 3 (L3) cache. The L3 cache can be connected to a Video Random Access Memory (VRAM) by a high-speed bus that can transfer data at a rate of tens of gigabytes per second. The VRAM can also be connected to the PCIe, and the PCIe can interconnect with other components on the computer, such as a Central Processing Unit (CPU), Direct Memory Access (DMA), Dynamic Random Access Memory (DRAM), Solid State Drive (SSD), a Serial Advanced Technology Attachment (SATA) controller that can control a Hard-Disk Drive (HDD), Read-Only Memory (ROM), Network Interface Card (NIC), and/or a Peripheral Input Output Controller (PIOC). The NIC can control access to both wired and wireless networks, while the PIOC can control input and output peripherals, such as a keyboard, a monitor, a mouse, and/or USB drives.

Conventionally, the CPU can be considered the master of the PCIe bus and can run an operating system for the computer, as well as other programs that can be stored in DRAM. The CPU typically has a few cores, usually less than ten, that can share a cache. The Basic Input-Output System (BIOS) can be stored in the ROM and can be first executed when the CPU starts. The BIOS can load the operating system from the HDD to the DRAM from where it can be executed. In order to fetch data from HDD, the CPU can first request the data from the SATA controller which can fetch data from the HDD. The SSD can store several pieces of data including program files, as well as programs themselves, for long term storage. When required, the CPU can fetch data from the SSD. However, the SSD capacity can be smaller than HDD but significantly faster than HDD.

In general, an important component for bulk fetching data from memory can be the DMA. The DMA can enable transfer of data directly from the HDD or SSD to the DRAM or to the VRAM. When several megabytes of data need to be processed, transferring this data piece by piece from the DRAM to the VRAM or from the SSD/HDD to DRAM or VRAM can be slow because the PCIe bus contention can require being resolved for each piece of data. As a result, the DMA controller can be given responsibility by the CPU to transfer data in bulk between memories without interruption and to alert the CPU when this process is complete. During this bulk transfer process, the DMA can become the master of the PCIe bus.

The process by which the GPU works can be explained below. The GPU can be a data cruncher or given a program and data to work on, and the GPU can process the data by using all its available cores. Thus, parallel processing can considerably occur. Generally, the steps that can take place for GPU processing can include: (1) the CPU can instruct the DMA to copy data and programs from the SSD or HDD to the DRAM; (2) the CPU can instruct the DMA to copy this data and programs from DRAM to the VRAM; (3) the CPU can instruct the GPU to begin processing; (4) the GPU can execute the program and fetch chunks of data from the VRAM, as required; (5) the GPU can interrupt the CPU when the program completes; (6) the CPU can fetch processed data from VRAM and store in DRAM; and (7) the CPU can use the results of GPU's computation for further processing or for displaying data to the user.

A Resource Description Framework (RDF) is a graphical database for storing information in triples. Generally, RDF 1.1 is a global standard issued by the World Wide Web Consortium (W3C). RDF can be used for storing all kinds of data for which relational databases can be inefficient in terms of performance and space. Typically, the data items in RDF can be Uniform Resource Identifiers (URI) and string literals. For example, as depicted in FIG. 2, Wikipedia.org provides an example on http://en.wikipedia.org/wiki/Tony_Benn> <http://purl.org/dc/elements/1.1/title. The statement “Resource Tony_Benn in wikipedia with title ‘Tony_Benn’”, is captured by two URI's and a string literal, “Tony Benn”. RDFs can be depicted graphically, as shown in FIG. 2. For the above example, a resource can also be referred to as the subject or parent, and the relationship can be called a predicate. The target of the relationship can be called the object or the child of the parent.

As can be seen, the identifiers used in an RDF can be of variable length. Therefore, for searching and retrieving an RDF, variable length identifiers may need to be searched. Storing variable length identifiers is actually memory-efficient, but when searching and retrieving this data using CPU-based techniques, searching takes a long time simply because the matrix representation can be sparse. Moreover, parallelizing techniques on the CPU may not be scalable.

### SUMMARY

Embodiments of the present disclosure generally provide a method for searching and retrieving variable-length identifiers. The method may provide searching and retrieving triples from a datastore. The datastore may be a Resource Description Framework (RDF) compliant triples datastore. The method may further provide processing each triple utilizing a Graphics Processing Unit (GPU). The GPU may be utilized in parallel with a Central Processing Unit (CPU). The method may provide identifying matches and non-matches of parent subjects and parent objects with search targets. Each variable-length identifier may be assigned up to a variable length of 54 bits and may have a maximum ID size of 2⁵⁴−1. The datastore may have a parent-child relationship among its entities. Native storage format may be used rather than a relational database. The GPU may process data in chunk sizes of 64 kilobytes (KB).

Other embodiments of the present disclosure may provide a system for searching and retrieving variable-length identifiers. The system may provide a datastore that may store triples. The datastore may be a Resource Description Framework (RDF) compliant triples datastore. The system may provide a Graphics Processing Unit (GPU) that may be configured to process each triple. The GPU may be utilized in parallel with a Central Processing Unit (CPU). The system may further provide search targets that may match and may not match parent subjects and parent objects. Each variable-length identifier may be assigned up to a variable length of 54 bits and may have a maximum ID size of 2⁵⁴−1. The datastore may have a parent-child relationship among its entities. Native storage format may be used rather than a relational database. The GPU may process data in chunk sizes of 64 kilobytes (KB).

Further embodiments may provide a method for completing a Resource Description Framework (RDF) search comprising: utilizing a Central Processing Unit (CPU), obtain a search target from a client, wherein the search target is either a parent subject or object; sending subject/object or object/subject chunks from a disk to video random access memory (VRAM) or from dynamic random access memory (DRAM) to VRAM if not already cached; and initiating a Graphics Processing Unit (GPU) kernel for each chunk sent to VRAM, wherein child subjects or objects returned from the GPU are answer to the search target from the client. The initiating step may further comprise for each GPU kernel, scheduling 2¹⁴ threads per chunk; for each thread, evaluating whether an atomic flag is set; upon determining an atomic flag is set, checking the threads corresponding section to see if it is a parent subject or object that matches the search target; upon determining that it matches the search target, setting the atomic flag to tell new threads beginning execution to short circuit and stop execution; and copying back the child subjects or objects after the matching parent to the CPU. Upon determining the atomic flag is not set, stopping thread execution. Upon determining that it does not match the search target, stopping thread execution.

Embodiments of the present disclosure may provide a method for searching and retrieving variable-length identifiers, as shown and described herein.

Embodiments of the present disclosure may provide a system for searching and retrieving variable-length identifiers, as shown and described herein.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 depicts a Graphics Processing Unit (GPU) based computer system and method of the prior art according to an embodiment of the present disclosure;

FIG. 2 depicts a Resource Description Framework (RDF) of the prior art according to an embodiment of the present disclosure;

FIG. 3 depicts assigning bits to identifiers according to an embodiment of the present disclosure;

FIG. 4 depicts aligning identifiers to boundaries according to an embodiment of the present disclosure;

FIG. 5 depicts processing data in chunks according to an embodiment of the present disclosure;

FIG. 6 depicts a process for completing a fast search according to an embodiment of the present disclosure;

FIG. 7A depicts object/subject (O/S) chunk (64 KB) according to an embodiment of the present disclosure;

FIG. 7B depicts subject/object (S/O) chunk (64 KB) according to an embodiment of the present disclosure;

FIG. 8 depicts a graph comparing CPU versus GPU over time according to an embodiment of the present disclosure; and

FIGS. 9A and 9B depict holding subjects with variable values according to embodiments of the present disclosure.

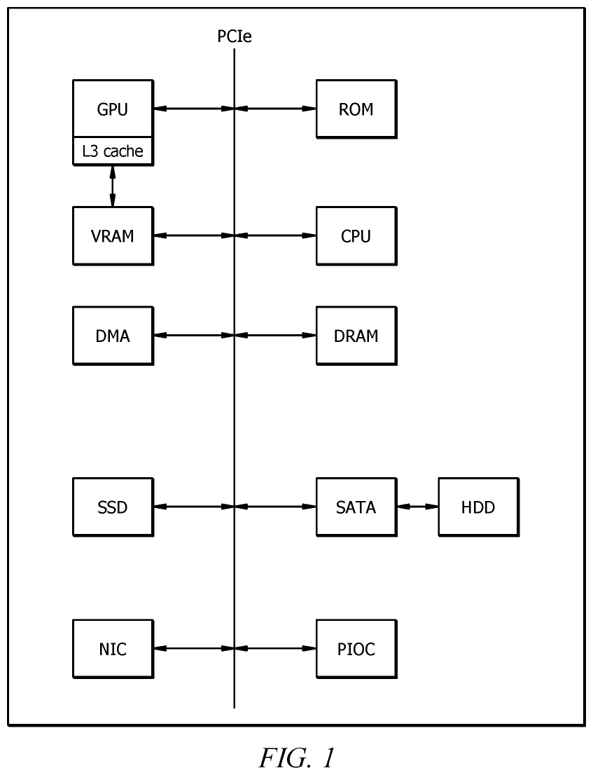

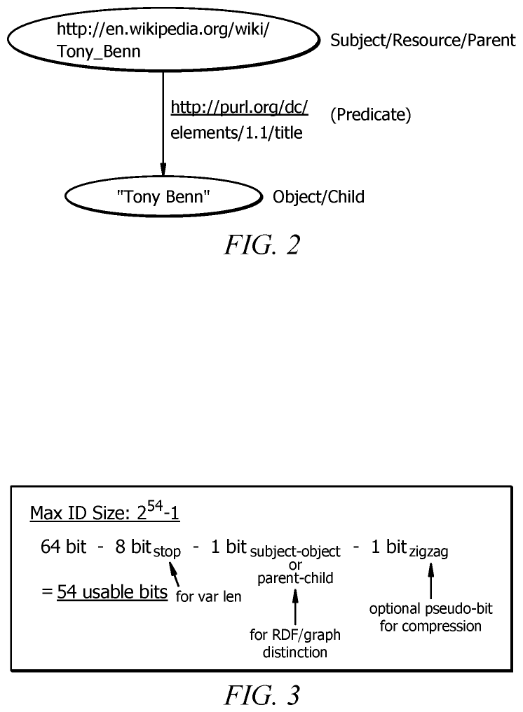

### DETAILED DESCRIPTION

Embodiments of the present disclosure generally provide a system and method for searching and retrieving variable-length identifiers using a GPU. The system and method may conduct a fast search and retrieval of RDF triple stores on a GPU, in which search and retrieval may be exclusively be conducted on the GPU. The system and method may provide fast and efficient parallel processing of the search and retrieval operation of variable length identifiers on the GPU.

FIG. 3 depicts assigning bits to identifiers according to embodiments of the present disclosure. Each identifier may be assigned up to a variable length of 54 bits and may have a maximum ID size of 2⁵⁴−1. For example, 64 bit−8 bitₛₜₒₚ−1 bit_{subject-object OR parent-child}−1 bit_{zigzag} may provide 54 usable bits. It should be appreciated that there may be more or less than 54 bits without departing from the present disclosure. It should also be appreciated that a “stop” may be utilized for a variable length. It should further be appreciated that “parent-child” may be utilized for an RDF and/or graph distinction. It should be appreciated that “zigzag” may provide an optional pseudo-bit for compression of data. It should be appreciated that searching and retrieving triples from a datastore may include RDF datastores and other datastores that have a parent-child relationship among its entities including, but not limited to, any key-value stores and/or pairs.

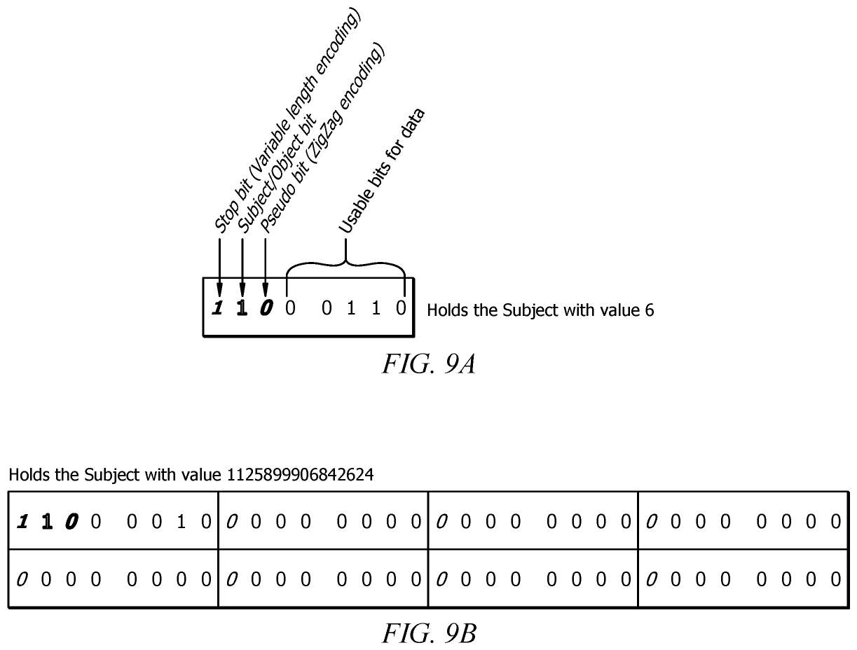

FIGS. 9A and 9B depict holding subjects with variable values according to embodiments of the present disclosure. The first bit (1) in FIG. 9A is the stop bit for variable length encoding. The second bit (1) is the subject/object bit. The third bit (0) is the pseudo bit for zigzag encoding, and the remaining bits are the usable bits for data according to an embodiment of the present disclosure. FIG. 9B depicts another embodiment that holds the subject with a value of 1125899906842624. If this was an object and was after the first object in a chain, it should be appreciated that the data bits would be zigzag decoded and then delta decoded to get the value.

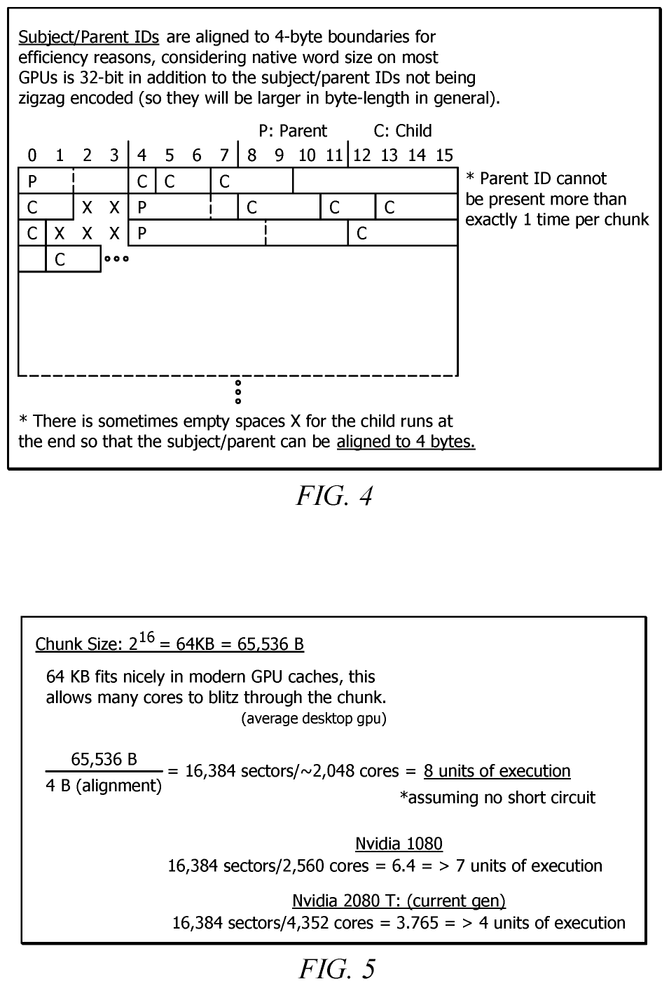

FIG. 4 depicts aligning identifiers to boundaries according to an embodiment of the present disclosure. Subject/parent identifiers may be aligned to 4-byte boundaries that may improve processing efficiencies. Native word size may be utilized on most GPUs which may provide a 32-bit size. Subject/parent identifiers may not be zigzag encoded but may generally be larger in byte-length in embodiments of the present disclosure. It should be appreciated that the parent ID may not be present more than exactly one time per chunk. It should also be appreciated that empty spaces may be provided for the child and run at the end in order to align the subject/parent to 4 bytes.

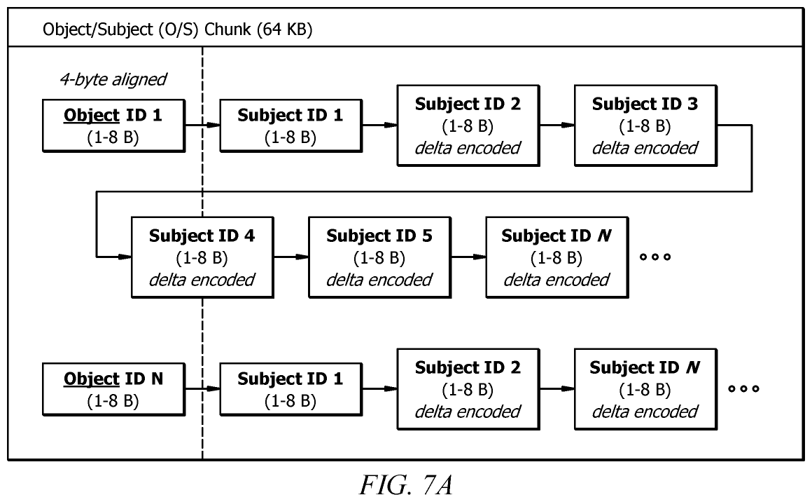

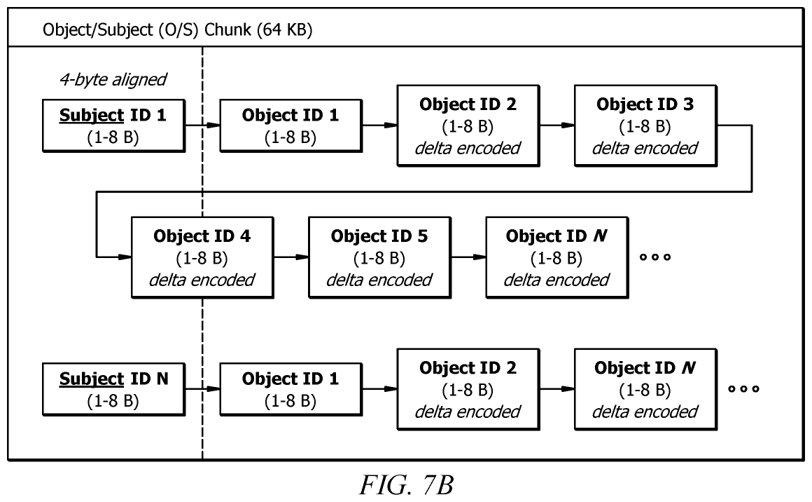

FIG. 5 depicts processing data in chunks according to an embodiment of the present disclosure. The GPU may process data in chunk sizes of 2¹⁶ bytes or 64 kilobytes (KB), as depicted in FIG. 5. It should be appreciated that 64 KB may fit nicely in modern GPU caches and may allow a plurality of cores to blitz through a chunk. As reflected in FIG. 5, when there is 4-byte alignment over 64 KB, there may be 16,384 sectors or approximately 2048 cores which may equate to 8 units of execution assuming no short circuit. If there are more cores, then there are fewer units of execution as noted in FIG. 5. FIGS. 7A and 7B depict object/subject (O/S) chunk (64 KB) and subject/object (S/O) chunk (64 KB) respectively with 4-byte alignment according to an embodiment of the present disclosure.

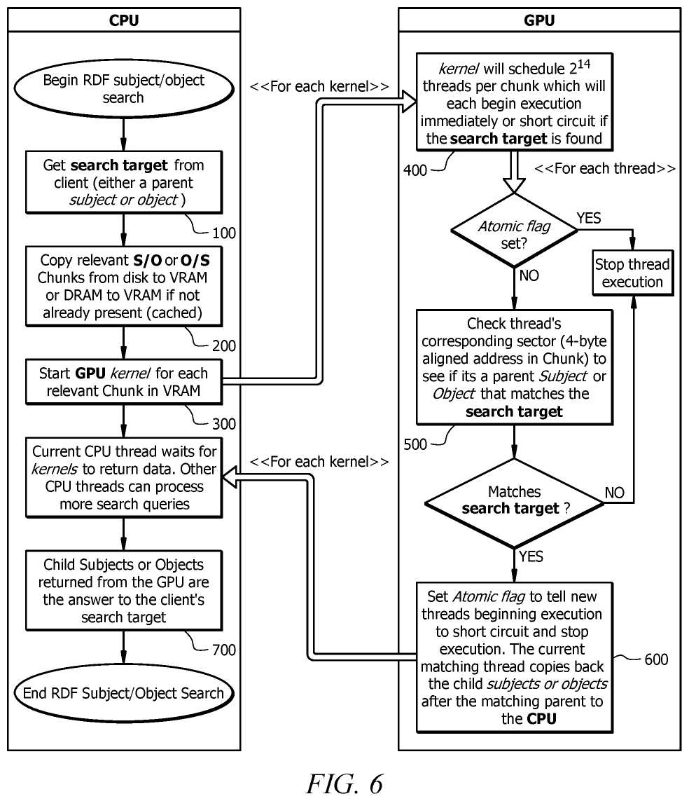

FIG. 6 depicts a process for completing a fast search according to an embodiment of the present disclosure. A 64 KB chunk may contain either parent subjects and child objects or parent objects and child subjects. The process may begin by utilizing a CPU to search a target that may be provided by a client, such as a parent subject or object (100). From the CPU, relevant chunks may be sent or copied from a disk to VRAM or from DRAM to VRAM if not already present or cached (200). Still from the CPU, a GPU kernel may be initiated for each chunk that was sent to VRAM (300). It should be appreciated that the CPU may only handle user interactions in embodiments of the present disclosure. However, it should be appreciated that the CPU may handle additional tasks without departing from the present disclosure.

During the process for completing a fast search, a GPU may be utilized in parallel with the CPU, in which the kernel may automatically schedule warps of 32 threads that may each begin execution immediately or may short circuit if a search target is found (400). For each kernel, the kernel may schedule 2¹⁴ threads per chunk which may each begin execution immediately or short circuit if the search target is found. It should be appreciated that the GPU memory may be filled with data directly from the memory controller of the motherboard, and the CPU may be almost completed unused during search and retrieval operation. It should be appreciated that triples may be stored on the GPU memory. It should also be appreciated that new triples may be added to a datastore if the triple does not exist in the datastore. For each thread, it may be determined if an atomic flag is set. If not, then from the GPU, each thread may check its corresponding sector, which may be a 4-byte aligned address in a chunk, to determine whether a parent subject or object is identified and matches the search target (500). If an atomic flag is set, the thread execution may be stopped. If a match is not made, the GPU core may terminate.

After being successfully matched, from the GPU, an atomic flag may be set to instruct new warps that may begin execution to short circuit (600). This atomic flag may tell new threads beginning execution to short circuit and stop execution. The current matching thread copies back the child subjects or objects after the matching parent to the CPU. If more than one GPU finds a match, the CPU may have multiple matches. It should be appreciated that a current thread may serially copy back the following child subject or object to the CPU. It should also be appreciated that warps from the same kernel may terminate. Once the GPU kernel completes execution, from the CPU, child subjects or objects returned from the kernel may be the answer to the original client's search target (700). It should be appreciated that after the GPU kernel is initiated (300), the current CPU thread may wait for the kernel to return data. It should also be appreciated that other CPU threads may process additional queries. It should further be appreciated that after the CPU thread waits for the kernel to return data, child subjects or objects returned from the kernel may be the answer to the original client's search target (700).

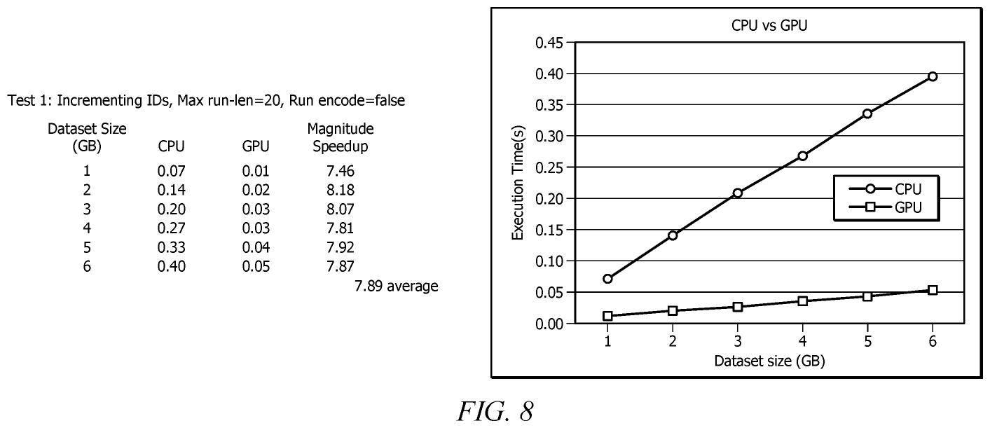

FIG. 8 depicts a graph comparing CPU versus GPU over time according to an embodiment of the present disclosure. As the dataset size (in GB) increases, the execution time (in seconds) reflects a 7.89 average magnitude speedup when comparing CPU to GPU. In additional embodiments of the present disclosure, incrementing IDs, a dataset of 6 GG, a 20 max run, and no delta encode may result in 113,633,410 Subjects 1,192,599,544 Objects, while using a delta encode may result in 313,303,301 Subjects and 3,289,057,731 Objects. In other embodiments of the present disclosure, random IDs, a dataset of 6 GB, 20 max run, and no delta encode may result in 73,165,580 Subjects and 767,865,086 Objects, while using a delta encode may result in 73,158,986 Subjects and 767,869,096 Objects.

It should be appreciated that addressable chunks in VRAM inside of the GPU may utilize a novel 32-bit pointer that may allow a maximum of 256 GPUs to work in tandem. It should also be appreciated that a total addressable RAM of 1 TB may be permissible in 64 KiB (2\hat{ }16 bytes) chunks that may provide a nearly inexhaustible high-speed memory for GPU processing. It should be appreciated that an allocation of memory space for processing triples inside GPU memory may be provided upfront. Searching by subject, object, and/or predicate may be provided on a triple and different permutations of these parameters may provide approximately 8 ways of searching. It should be appreciated that more or fewer ways of searching may be provided.

It should be appreciated that the system and method for searching and retrieving variable-length identifiers may be utilized in industries including, but not limited to, health informatics, bioinformatics, big data, and/or any domain in which linked-data information may need processing. It should be appreciated that the system and method for searching and retrieving variable-length identifiers may provide a more efficient process. It should also be appreciated that search and retrieval may be performed exclusively on the GPU that provide extreme parallelism and higher performance than traditional systems and methods. It should be appreciated that the system and method for searching and retrieving variable-length identifiers may be utilized as a string store, a key-value pair store, and/or as a triple store. It should be appreciated that the system and method for searching and retrieving variable-length identifiers may optimize data transposition by matching endian-ness of the system or method. It should be appreciated that processing a triples datastore may immediately be initiated.

It should be appreciated that the system and method for searching and retrieving variable-length identifiers may provide a high reduction of an input/output (I/O) system by enabling the triples database to work directly with a memory-mapped model. It should also be appreciated that a word-aligned hybrid data structure may be highly optimized for binary storage and may provide compression for all data structures in a datastore. It should further be appreciated that the system and method for searching and retrieving variable-length identifiers may provide a single logical branchless operation for comparing variable length identifiers on the GPU. It should be appreciated that the system and method for searching and retrieving variable-length identifiers may provide a main memory that may be partitioned into two components or parts for caching the components of RDF triples.

It should be appreciated that the system and method for searching and retrieving variable-length identifiers may be utilized for searching a native storage format or NoSQL and may not be built on a relational database for efficiency reasons. It should also be appreciated that the system and method for searching and retrieving variable-length identifiers may search identifiers by utilizing pattern matching on grouped partitions and may not be graph-based. It should further be appreciated that key-value memory representation may not be utilized because utilizing additional structures may increase GPU memory congestion and may reduce performance.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for searching and retrieving variable-length identifiers, comprising:
searching and retrieving triples from a datastore, wherein the datastore is a Resource Description Framework (RDF) compliant triples datastore or any key-value stores;
processing each triple utilizing a Graphics Processing Unit (GPU), wherein the GPU is utilized in parallel with a Central Processing Unit (CPU); and
identifying matches and non-matches of parent subjects and parent objects with search targets.

2. The method of claim 1, wherein each variable-length identifier is assigned up to a variable length of 54 bits.

3. The method of claim 1, wherein each variable-length identifier has a maximum ID size of 2⁵⁴−1.

4. The method of claim 1, wherein the datastore has a parent-child relationship among its entities.

5. The method of claim 1, wherein native storage format is used rather than a relational database.

6. The method of claim 1, wherein the GPU processes data in chunk sizes of 64 kilobytes (KB).

7. A system for searching and retrieving variable-length identifiers, comprising:
a datastore provided to store triples, wherein the datastore is a Resource Description Framework (RDF) compliant triples datastore or any key-value stores;
a Graphics Processing Unit (GPU) configured to process each triple, wherein the GPU is utilized in parallel with a Central Processing Unit (CPU); and
search targets provided to match and not match parent subjects and parent objects.

8. The system of claim 7, wherein each variable-length identifier is assigned up to a variable length of 54 bits.

9. The system of claim 7, wherein each variable-length identifier has a maximum ID size of 2⁵⁴−1.

10. The system of claim 7, wherein the datastore has a parent-child relationship among its entities.

11. The system of claim 7, wherein native storage format is used rather than a relational database.

12. The system of claim 7, wherein the GPU processes data in chunk sizes of 64 kilobytes (KB).

13. A method for completing a Resource Description Framework (RDF) search comprising:
utilizing a Central Processing Unit (CPU), obtain a search target from a client, wherein the search target is either a parent subject or object;
sending subject/object or object/subject chunks from a disk to video random access memory (VRAM) or from dynamic random access memory (DRAM) to VRAM if not already cached; and
initiating a Graphics Processing Unit (GPU) kernel for each chunk sent to VRAM, wherein child subjects or objects returned from the GPU are answer to the search target from the client.

14. The method of claim 13, the initiating step further comprising:
for each GPU kernel, scheduling 2¹⁴ threads per chunk;
for each thread, evaluating whether an atomic flag is set;
upon determining an atomic flag is set, checking the threads corresponding section to see if it is a parent subject or object that matches the search target;
upon determining that it matches the search target, setting the atomic flag to tell new threads beginning execution to short circuit and stop execution; and
copying back the child subjects or objects after the matching parent to the CPU.

15. The method of claim 14, wherein upon determining the atomic flag is not set, stopping thread execution.

16. The method of claim 14, wherein upon determining that it does not match the search target, stopping thread execution.
